(19) United States
(12) Patent Application Publication
(10) Pub. No.: US 2008/0097086 A1
(43) Pub. Date: Apr. 24, 2008

(54) Process for preparing anti-tumor oligosaccharide material from chitosan

(75) Inventor: San-Lang Wang, Taipei County (TW)

Correspondence Address: BACON & THOMAS, PLLC, 625 SLATERS LANE, FOURTH FLOOR, ALEXANDRIA, VA, 22314, US

(73) Assignee: TENWELL BIOTECHNOLOGY LIMITED, Gueishan Township (TW)

(21) Appl. No.: 11/898,099

(22) Filed: Sep. 10, 2007

(30) Foreign Application Priority Data
Oct. 19, 2006 (TW) 095138922

(51) Int. Cl. C08B 37/08

(52) U.S. Cl. 536/20

(57) ABSTRACT

The present invention relates to a process for preparing chito-oligosaccharide material by the enzymatic hydrolysis of chitinous materials, such as chitin, chitosan, and squid pen. The results of cell experiment showed that the oligosaccharide material of the invention causes a decrease in survival rate of U937 cell (a human leukemia cell line) to 69-57%; and of CT26 (a mouse rectal carcinoma cell line) to 69-57%. The product of the invention is preferably in form of tablet, capsule, powder, and granules. It may be added to any kind of foods as a nutriment, which is administered orally as an anti-tumor auxiliary.

### FIELD OF INVENTION

The present invention provides a process for preparing anti-tumor oligosaccharide material by the enzymatic hydrolysis of chitinous materials, such as chitin, chitosan, and squid pen.

### BACKGROUND OF INVENTION

Following related investigations report the anti-tumor efficacy of chito-oligosaccharide:

In 1986, Suzuki et al. (Suzuki K, Mikami T, Okawa Y, et al. Antitumor effect of hexa-N-acetylchitohexaose and chitohexaose. Carbohydrate Research, 1986, 151: 403) reported the anti-tumor effects of chito-oligosaccharide. The investigators injected chitohexaose intravenously into S180-implanted ddY mice, and found a significantly inhibitory effect on the growth of tumor cell after incubation for seven days as follow: 3 times at 100 mg/Kg/d to obtain inhibitory rate of 85% and 93%; and to achieve complete control of tumor growth when increased to 5 times.

After that, Suzuki et al. (Tokro A, Suzuki K, Mikami T, et al. Growth-inhibitory effect of hexa-N-acetylchitohexaose and chitohexaose against Meth-A solid tumor. Chem Pharm Bull 1998, 36(2): 784) demonstrated that chitohexaose exhibited significant inhibition on fibrosarcoma (Meth-A) solid tumor cells. It was suggested that dose of 10 mg/Kg displays the strongest effect. They also explained the mechanism of chitohexaose action on anti-tumor by improving immune system.

In 1990, Ouchi-T et al. (Ouchi T, Banba Matsumoto T, et al. Synthesis and anti-tumor activity of conjugates of 5-fluorouracil and chito-oligosaccharides involving a hexamethylene spacer group and carbamoyl bonds. Drug Des Dellv '1990 October 6(4): 281) discovered a stronger anti-tumor effect of the conjugate of 5-fluorouracil (5-FU) with three chito-oligosaccharides than 5-FU. The conjugates prolonged the longevity of P338 lymphocytic leukemia mice by intraperitoneal administration to the mice. It was also found that the conjugates induced inhibition to tumor growth through subcutaneous injection applied to mice with MeTH-A fibrosarcoma or MH134 hepatocarcinoma. The treatment with such conjugates has following advantages: (1) without causing any acute toxicity; and (2) without causing rapid weight losing.

A further study disclosed that chito-oligosaccharides exhibited their anti-tumor function by enhancing activity of killer cells of intraepithelial lymphocytes in intestinal wall. (Yasunori Maeda, Yoshiyuki Kimura. Antitumor Effects of Various Low-Molecular-Weight Chitosans Are Due to Increased Natural Killer Activity of Intestinal Intraepithelial Lymphocytes in Sarcoma 180-Bearing Mice, J. Nutr. 134: 945-950).

In all the experiments described above, chitohexaose was used as the studying material, and intravenous injection or intraperitoneal injection as the route of administration. However, in commercial application, it is required complex procedures to isolate chitohexaose, and the purified material with very low yield, which limiting the use of chitohexaose.

Therefore, the process of the invention provides industrialized production of chito-oligosaccharides using commercially available chitosan and enzyme by controlling relative concentration and reaction time, and also establishes the preparing conditions. It further discloses that chito-oligosaccharides obtained according to the invention decrease the survival rate of human leukemia cell line U937 to 69-57%; and of mouse rectal carcinoma cell line CT26 to 69-57%.

### SUMMARY OF INVENTION

The present provides a process for preparing chito-oligosaccharides with high concentration, which utilizing chitinous materials enzymatically hydrolyzed under the controlled conditions of certain type and concentration of the substrate, enzyme type, enzyme concentration, and reaction time.

The chito-oligosaccharide of the invention is preferably in a form of tablet, capsule, powder, and granules. It may be added to any kind of foods as a nutriment, which is administered orally as an anti-tumor auxiliary.

### BRIEF DESCRIPTION OF FIGURES

FIG. 1 illustrates the inhibitory effects of chito-oligosaccharides (A) and (B) of the invention on human leukemia cell line U937.

FIG. 2 illustrates the inhibitory effects of chito-oligosaccharides (B) of the invention on mouse rectal carcinoma cell line CT26.

FIG. 3 show the observation of effects of chito-oligosaccharides (B) of the invention on the cell differentiation in human leukemia cell line U937.

FIG. 4 shows results of the NBT reducing test on human leukemia cell line U937 by chito-oligosaccharides (B) of the invention.

FIG. 5 illustrates the inhibitory effects of chito-oligosaccharides (A) on plant pathogen Fusarium oxysporum and human pathogen Aspergillus fumigatus.

### DETAIL DESCRIPTION OF INVENTION

The process for preparing chito-oligosaccharide of the invention comprises following steps: (1) dissolving the chitinous material in 0.05-0.5% acetate buffer at pH 3-6; (2) adding hydrolytic enzyme to the solution; and (3) performing the reaction at appropriate temperature for a definite period of time, then concentrating the supernatant at reduced pressure after filtration, and drying to obtain the chito-oligosaccharide.

According to the preparing process, the chitinous material may be selected from the group of chitin powder, squid pen, mushroom, and commercial crude chitosan; the hydrolytic enzyme may be papain or bromelain and at the concentration of 0.02-1 wt %; the hydrolytic reaction is performed at a controlled temperature and through stirring; and the drying method may be spray drying, lyophylization, and hot air drying.

The following examples are provided for exemplifying, and not intending to limit the scope of the invention.

### EXAMPLE 1

100 gram of squid pen was dissolved in 3500 mL of sterile acetate buffer (at pH 4). After complete dissolving, 7.2 gram of bromelain (from CHALLENGE BIOPRODUCTS CO., LTD.) was added to the solution, and the mixture was reacted at 30° C. for 60 hours. The reaction mixture was shacked continuously on a constant temperature shaker. After complete reaction, the supernatant obtained by centrifugation and filtration was concentrated under reduced pressure and spray dried to provide chito-oligosaccharide (A) of the invention.

### EXAMPLE 2

10 gram of commercial chitosan powder was dissolved in 3500 mL of sterile acetate buffer (at pH 4). After complete dissolving, 3.5 gram of bromelain was added to the solution, and the reaction was performed at 32° C. for 80 hours. The reaction mixture was shaken continuously on a constant temperature shaker. After complete reaction, the supernatant obtained by centrifugation and filtration was concentrated under reduced pressure and spray dried to provide chito-oligosaccharide (B) of the invention.

### EXAMPLE 3

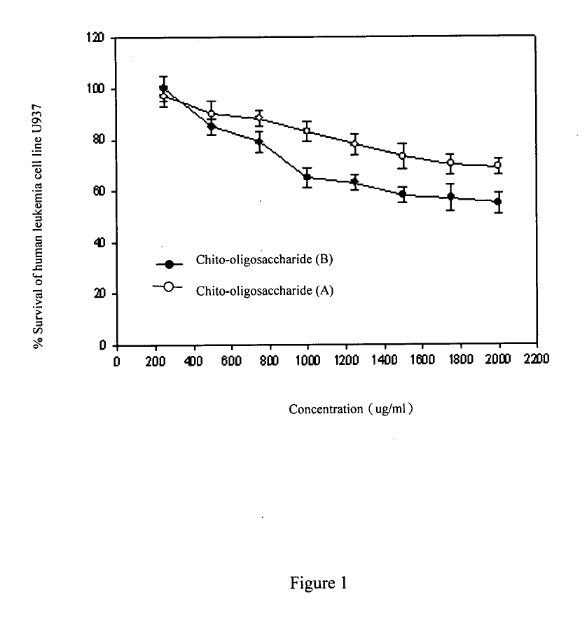

Various concentration of chito-oligosaccharides (A) and (B) obtained in Example 1 and 2 respectively were prepared for the inhibitory experiment on human leukemia cell line U937. As showed in FIG. 1, chito-oligosaccharides (A) and (B) of the invention decrease the survival rate of human leukemia cell line U937 to 69 and 57%, respectively.

### EXAMPLE 4

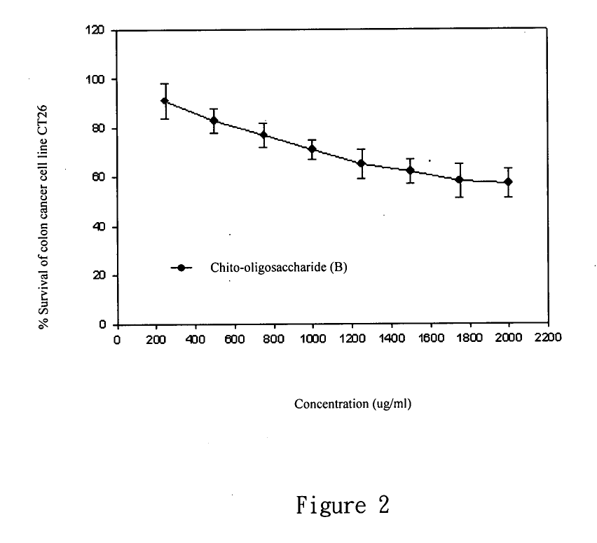

Various concentration of chito-oligosaccharide (B) obtained in Example 2 was prepared for the inhibitory experiment on mouse rectal carcinoma cell line CT26. As showed in FIG. 2, chito-oligosaccharide (B) of the invention decreased the survival rate of mouse rectal carcinoma cell line CT26 to 57%.

### EXAMPLE 5

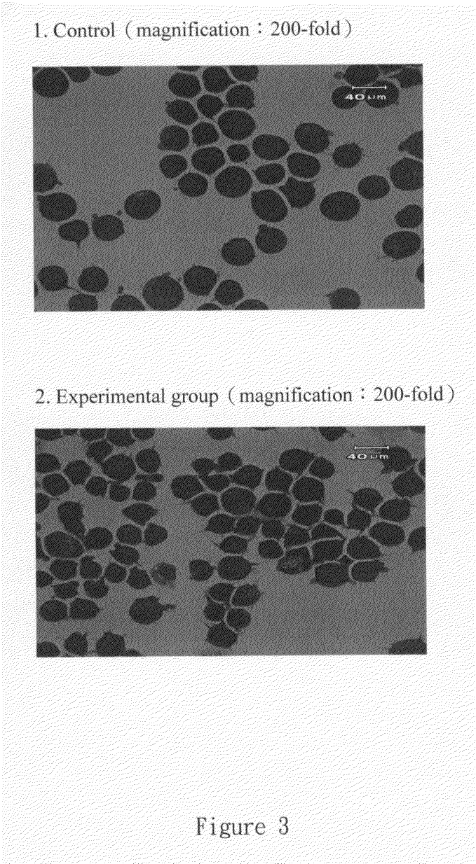

The effect of chito-oligosaccharide (B) of the invention at 2000 ug/ml on the cell morphology of human leukemia cell line U937 (in suspension cultivation) was observed. The results were showed in FIG. 3. For that mouse rectal carcinoma cell line CT26 belongs to adherent cell, it is not suitable for cell morphological observation. The cells were stained with Liu′ S stain, in which Liu′ A solution was red for staining cytosol, and Liu′ B solution was blue for staining nucleus.

As comparing the experimental and control groups in FIG. 3, after treatment of chito-oligosaccharide (B), the ratio of nucleus/cytosol was shifted to smaller value, and the cytosol was changed from more basophilic to lighter in color. Moreover, the number of nucleoli was decreased, and the tight and fine chromatin became loose and thick. The appearance of pseudopodia and phagocytosis vacuoles and the observation of few apoptosisomes suggest that chito-oligosaccharide (B) tends to make cancer cells become normal.

### EXAMPLE 6

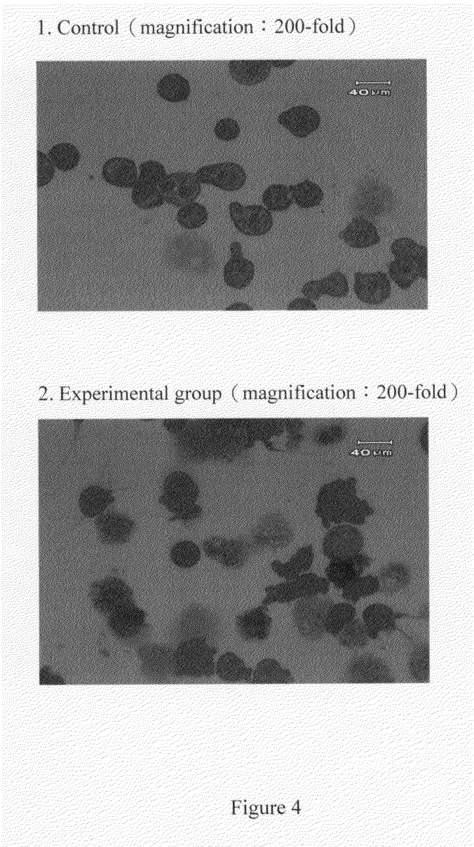

The Nitroblue tetrazolium (NBT) reduction test in human leukemia cell line U937 (in suspension cultivation) was performed with chito-oligosaccharide (B) of the invention at 2000 ug/ml. The results were showed in FIG. 4. For that mouse rectal carcinoma cell line CT26 belongs to adherent cell, it is not suitable for NBT reduction test. As comparing the experimental and control groups in FIG. 4, the NBT reduction test in chito-oligosaccharide (B) treated human leukemia U937 cell showed the dark blue formazan deposited on cytosol, indicated that the human leukemia U937 cell had differentiated. By judging from the result, chito-oligosaccharide (B) of the invention shut down the survival of U937 cell to ½, and induced the differentiation of remaining U937 cells to normal cells. Although the number of positive cells is not large, it is still a good phenomenon that chito-oligosaccharide (B) treated human leukemia U937 cells are led to differentiation.

### EXAMPLE 7

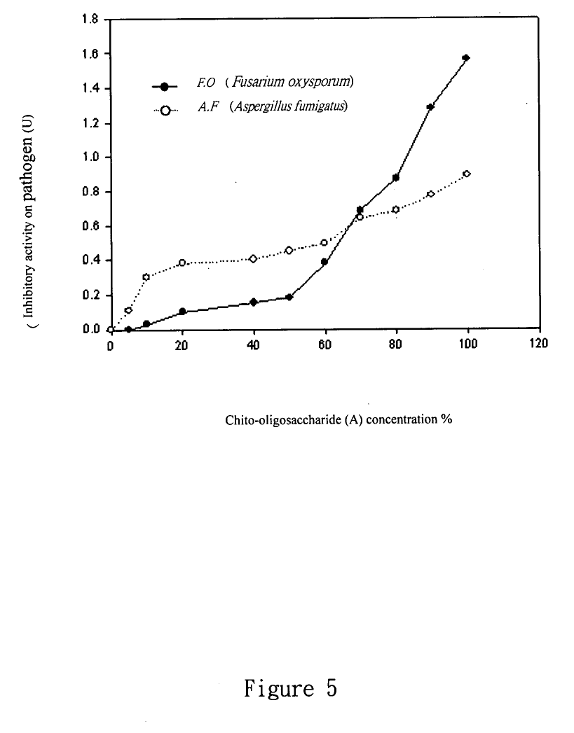

The inhibitory effect of chito-oligosaccharide (A) of the invention on plant pathogen Fusarium oxysporum (briefly called F.O) and human pathogen Aspergillus fumigatus (briefly called A.F) was tested at various concentrations (0%-100%). As the result showed in FIG. 5, the antimycotic activity of chito-oligosaccharide (A) was dose dependant. Obviously, the growth of Fusarium oxysporum was controlled to reach an inhibitory activity of 1.6U when treated with 100% of chito-oligosaccharide (A). It also found that higher inhibitory activity on Aspergillus fumigatus could be gained by higher concentration of chito-oligosaccharide (A).

1. A preparing method for anti-tumor chito-oligosaccharide, which comprising:
(1) dissolving the chitinous material in 0.05-0.5% acetate buffer at pH 3-6;
(2) adding hydrolytic enzyme to the solution; and
(3) performing the reaction at appropriate temperature for a definite period of time, then concentrating the supernatant at reduced pressure after filtration, and drying to obtain the product.

2. A preparing method of claim 1, wherein the chitinous material is selected from the group of chitin powder, squid pen, mushroom, and commercial crude chitosan.

3. A preparing method of claim 1, wherein the hydrolytic enzyme is selected from papain or bromelain, and the enzyme concentration is between 0.02-1 wt %; the hydrolytic reaction is performed at a temperature range of 20° C. to 50° C. for 12-72 hours.

4. A preparing method of claim 1, wherein the drying method is selected from spray drying, lyophylization, and hot air drying.
